(19) United States
(12) Patent Application Publication
(10) Pub. No.: US 2004/0224557 A1
(43) Pub. Date: Nov. 11, 2004

(54) System and method of detecting and particularly identifying controlled devices

(76) Inventor: Barbara Jane Wight, Regensburg (DE)

Correspondence Address: MORGAN LEWIS & BOCKIUS LLP, 1111 PENNSYLVANIA AVENUE NW, WASHINGTON, DC, 20004, US

(21) Appl. No.: 10/701,076

(22) Filed: Nov. 5, 2003

Related U.S. Application Data
(60) Provisional application No. 60/424,291, filed on Nov. 5, 2002.

(51) Int. Cl. H01R 11/00

(52) U.S. Cl. 439/502

(57) ABSTRACT

A system and method of ensuring multiple devices, which are connected in series with a controller, can be detected by and particularly identified by the controller.

### CROSS REFERENCE TO RELATED APPLICATIONS

This application claims the benefit of the earlier filing date of U.S. Provisional Application No. 60/424,291, filed 5 Nov. 2002, which is incorporated by reference herein in its entirety.

### FIELD OF THE INVENTION

A system according to the present invention is capable of ensuring that multiple devices, which are to be connected in series with a controller, are connected sequentially so as to enable the controller to particularly identify each device. In particular, a system according to the present invention incorporates a feature that ensures that even identical devices, which are to be connected in series, in a sequential order, are connected with the device closest to the controller connected first.

### BACKGROUND OF THE INVENTION

In conventional heating, ventilating, and air conditioning (HVAC) systems, such as those fitted to a vehicle, it is difficult to ensure that, during the assembly process or in servicing the system, multiple actuators are connected to the wiring harness in the correct sequential order. Conventionally, following a predefined assembly sequence is important because this enables a controller for the HVAC system to identify which actuator is located at which physical location, and hence which function a particular actuator controls.

A first type of conventional HVAC system utilizes an actuator design feature, which can be either hardware or software, and which enables the controller to identify a particular actuator. Thus, each actuator in the system must have a unique feature to distinguish it from the other actuators. The first type of conventional HVAC systems suffers from a number of disadvantages including that multiple versions of essentially the same actuator are required. This results in different part numbers and additional logistical burdens both in assembly at a plant and during subsequent servicing, which result in higher costs.

A second type of conventional HVAC system utilizes a hardware feature in the mating couplings to identify a particular actuator location in the wiring harness. The second type of conventional HVAC systems suffers from a number of disadvantages including that multiple coupling variants are required, which results in higher system costs, and there is a need to have a foolproof method to ensure that the correct coupling variant is assembled in the correct location along the wiring harness. Examples of additional disadvantages include that hardware coding also requires four additional wires in the harness, which further increases system cost, and that the mechanical contacts are prone to oxidation that requires bursts of current to be supplied periodically to prevent contact issues.

### SUMMARY OF THE INVENTION

The present invention provides a control system that includes a controller, a wiring harness, and a plurality of devices. The wiring harness includes a first plurality of electrical couplings that are connected in series with the controller. A first one of the first plurality of electrical couplings is located along the harness closest to the controller, and a last one of the first plurality of electrical couplings is located along the harness furthest from the controller. Each of the plurality of devices is electrically connected via the wiring harness to the controller, and electrically connected to a respective one of the first plurality of electrical couplings via a corresponding one of a second plurality of electrical couplings. And sequential electrical connection of the corresponding one of the second plurality of electrical couplings with the first through the last ones of the first plurality of electrical couplings increases a closed path of devices that are detected and identified by the controller.

The present invention also provides a climate control system for a vehicle. The system includes a controller, a wiring harness, and a plurality of devices. The controller directs airflow to at least one of a footwell, interior vents, and a windshield defroster. The wiring harness includes a first plurality of electrical couplings connected in series with the controller. A first one of the first plurality of electrical couplings is located along the harness closest to the controller, and a last one of the first plurality of electrical couplings is located along the harness furthest from the controller. Each of the plurality of devices is electrically connected via the wiring harness to the controller, and electrically connected to a respective one of the first plurality of electrical couplings via a corresponding one of a second plurality of electrical couplings. And sequential electrical connection of the corresponding one of the second plurality of electrical couplings with the first through the last ones of the first plurality of electrical couplings increases a closed path of devices that are detected and identified by the controller.

The present invention also provides a method of assembling a system including a controller, a wiring harness having at least two electrically open ports connected in series with the controller, and at least two devices. The method includes identifying with the controller a first one of the devices when an electrical connection via a first one of the ports creates a closed path, and identifying with the controller a second one of the devices when an electrical connection via a second one of the ports expands the closed path.

The present invention further provides a method of assembling a system including a controller, a wiring harness having a plurality of electrically open ports connected in series with the controller, and a plurality of devices. The method includes defining a closed path including only the controller and a first one of the plurality of devices, and expanding the closed path so as to include only the controller, the first one of the plurality of devices, and a second one of the plurality of devices.

### BRIEF DESCRIPTION OF THE DRAWINGS

The accompanying drawings, which are incorporated herein and constitute part of this specification, illustrate presently preferred embodiments of the invention, and, together with the general description given above and the detailed description given below, serve to explain features of the invention.

FIG. 1 is a schematic illustration of a control system in accordance with the detailed description of a preferred embodiment, in which no devices are attached.

FIG. 2 is a schematic illustration of the control system shown in FIG. 1, in which a first device is attached, detected, and particularly identified.

FIG. 3 is a schematic illustration of the control system shown in FIG. 1, in which first and second devices are attached, detected, and particularly identified.

FIG. 4 is a schematic illustration of the control system shown in FIG. 1, in which a second device is attached, but is not detected or particularly identified.

FIG. 5 is a schematic illustration of a vehicle heating, ventilation, and air conditioning system.

### DETAILED DESCRIPTION OF THE PREFERRED EMBODIMENT

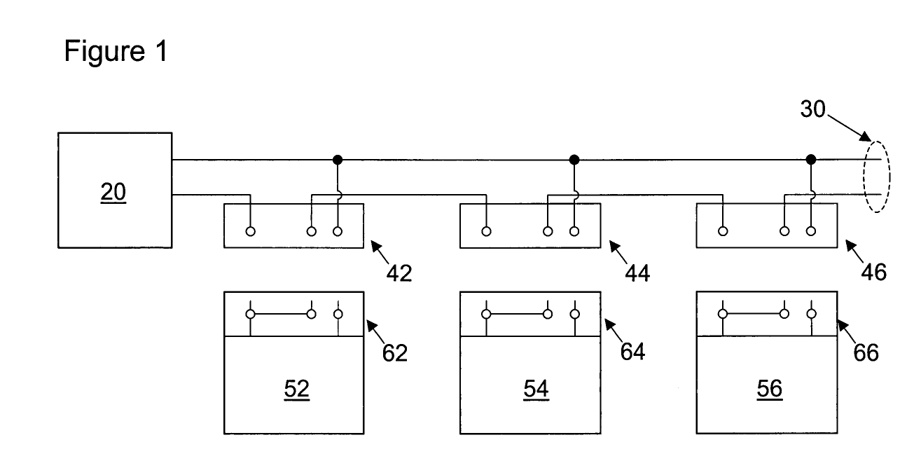

Referring initially to FIG. 1, a wiring harness 30 electrically connects a controller 20 so as to identify the presence of an actuator 52,54,56. The wiring harness 30 can include a power line or bus line if the actuator 52,54,56 is to communicate on a bus with the controller 20. Preferably, the wiring harness 30 defines a line that runs through the harness and loops through a set of first connectors 42,44,46. If one of the devices 52,54,56 is disconnected, the end of the loop is effectively removed causing an open port in the line at the respective one(s) of the set of first connectors 42,44,46.

It is a goal to ensure that the devices 52,54,56 are connected to the system in sequential order, starting with the device 52 that is nearest the controller 20 along the wiring harness 30. As shown in FIG. 1, the controller 20 is attached to the wiring harness 30, but no devices 52,54,56 are attached to the otherwise open ports at the set of first connectors 42,44,46.

According to a preferred embodiment, each of the set of first connectors 42,44,46 includes at least three contacts, which are matingly engageable with corresponding contacts on a set of second connectors 62,64,66, which are respectively associated with the devices 52,54,56.

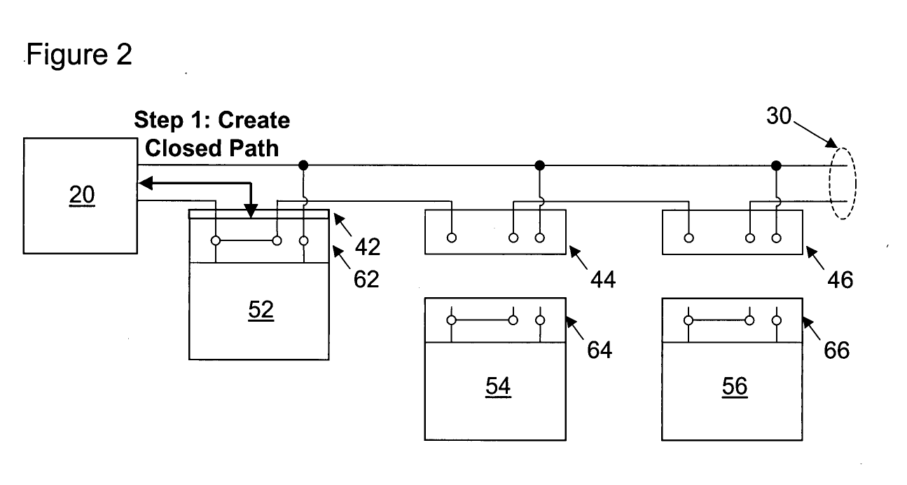

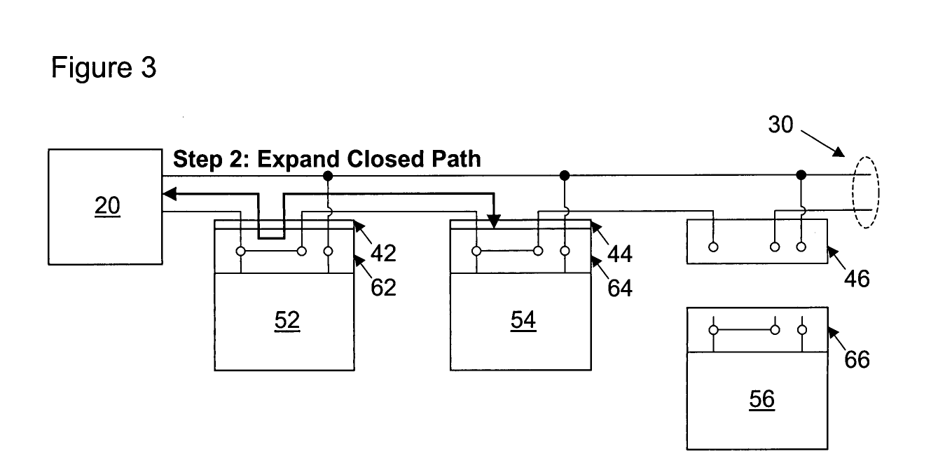

Referring now to FIGS. 2 and 3, any devices 52,54,56 on the far side of an open port with respect to the controller 20 will not be detected by the controller 20. Therefore, if devices 52,54,56 are connected sequentially and between each connection, feedback from the controller 20 is used to determine whether the controller 20 detected each new device 52,54,56, and the devices 52,54,56 can only be connected in one order. The device 52 nearest to the controller, measured along the wiring harness 30, must be connected before any other devices 54,56 to ensure a connection to the controller 20, and hence positive detection by the controller 20.

As shown in FIG. 2, the device 52 is connected correctly. That is to say, it is the first connected device and it is connected to wiring harness 30 at the connector 42, which is closest to the controller 20 along the wiring harness 30, and thereby creates a closed path that includes exclusively the controller 20 and the device 52.

As shown in FIG. 3, device 54 is subsequently connected correctly. That is to say, the device 54 is the second connected device and it is connected to wiring harness 30 at the connector 44, which is the second closest to the controller 20 along the wiring harness 30, and thereby creates a closed path that includes exclusively the controller 20, the device 52, and device 54. Thus, the correct procedure is: (Step 1) connect device 52 to connector 42 on the wiring harness 30, thereby creating a closed path including only controller 20 and device 52; and (Step 2) connect device 54 to connector 44 on the wiring harness 30, thereby expanding the closed path to include controller 20, device 52 and device 54. The controller 30 detects and identifies device 52 in Step 1, and then detects and identifies device 54 in Step 2.

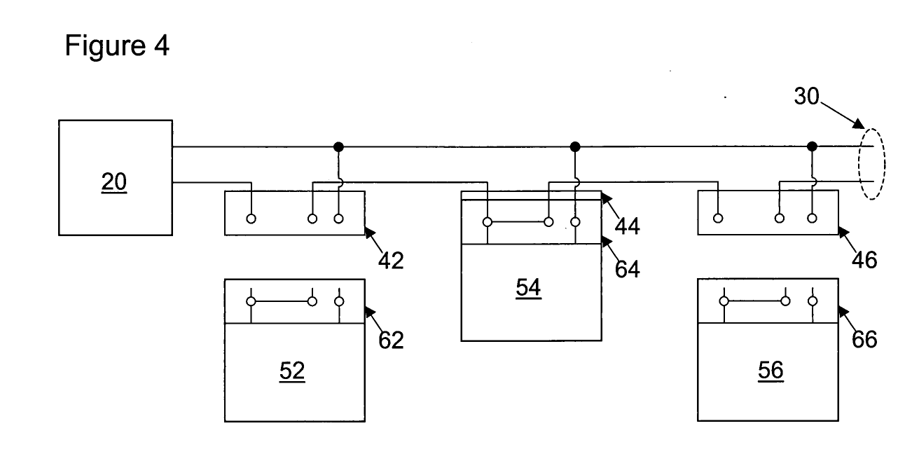

Referring now to FIG. 4, if a device 54 is connected out of sequence, the controller 20 will not be able to detect the device 54 because of the open port at the first connector 42 between the device 54 and the controller 20. Thus, an example of an incorrect assembly procedure that would be: initially connecting device 54 via first connector 44 to the wiring harness 30, i.e., before connecting first connecting device 52 via first connector 42. Because first connector 42 is open, the controller 20 unable to provide feedback that the connection of device 54 has been recognized, and an installer would not be able to confuse the connection of device 54 with the connection of device 52.

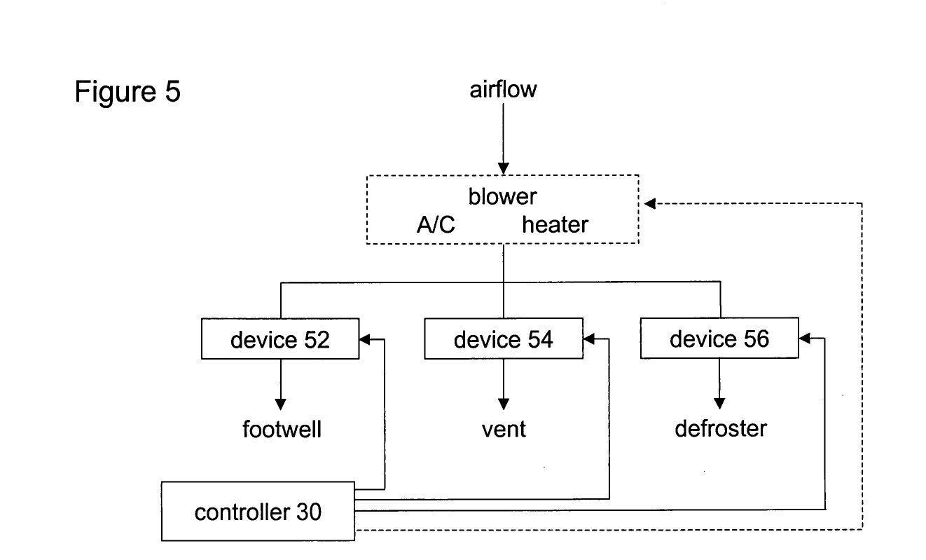

FIG. 5 shows a preferred embodiment according to the present invention of a heating, ventilating, and air conditioning (HVAC) system such as may be fitted to a vehicle. Airflow into the vehicle can be accelerated by a blower, e.g., a fan, and can be treated, e.g., by an air conditioner or a heater. The treated airflow can then be directed to one or more of a footwell, vent(s) or a window defroster. The controller 30 can select which one(s) of the blower, air conditioner and heater are used to treat the airflow, and drives devices 52,54,56, e.g., actuators, that regulate the distribution of the airflow to various portions of the passenger compartment, e.g., footwell, vent(s), or window defroster.

Advantages of the invention include utilizing identical devices 52,54,56 and identical connectors 42,44,46 in the wiring harness 30 so as to reduce the number of different parts required in the system. This is made possible, according to the invention, by ensuring that the devices 52,54,56 can only be connected in one sequence. The sequence of connection of the devices 52,54,56 to the system is also used by the controller 20 as the means of identifying each of the devices 52,54,56.

Using a diagnostic interface at the controller 20 after connection of each devices 52,54,56, the user can obtain feedback from the system that each of the devices 52,54,56 has been successfully detected and identified as being at a particular position along the wiring harness, and is therefore ready to perform a specific function. If one of the devices 52,54,56 is connected to a location out of sequence, the controller 20 will not be able to detect and identify the device 52,54,56, and no positive feedback will be provided by the controller 20. Thus, according to the present invention, it becomes impossible to connect the devices 52,54,56 in an incorrect sequence when using feedback from the controller 20.

While the present invention has been disclosed with reference to certain preferred embodiments, numerous modifications, alterations, and changes to the described embodiments are possible without departing from the sphere and scope of the present invention, as defined in the appended claims. Accordingly, it is intended that the present invention not be limited to the described embodiments, but that it have the full scope defined by the language of the following claims, and equivalents thereof.

What is claimed is:

1. A control system comprising:
a controller;
a wiring harness including a first plurality of electrical couplings connected in series with the controller, a first one of the first plurality of electrical couplings being located along the harness closest to the controller, and a last one of the first plurality of electrical couplings being located along the harness furthest from the controller; and
a plurality of devices electrically connected via the wiring harness to the controller, each of the plurality of devices being electrically connected to a respective one of the first plurality of electrical couplings via a corresponding one of a second plurality of electrical couplings;
wherein sequential electrical connection of the corresponding one of the second plurality of electrical couplings with the first through the last ones of the first plurality of electrical couplings increases a closed path of detected and identified devices, as recognized with the controller.

2. The control system according to claim 1, wherein a non-sequential electrical connection of the corresponding one of the second plurality of electrical couplings with the first through the last ones of the first plurality of electrical couplings opens the closed path.

3. The control system according to claim 2, wherein the devices are neither detected nor identified by the controller.

4. The control system according to claim 1, wherein each of the first plurality of electrical couplings are substantially identical, and each of the second plurality of electrical couplings are substantially identical.

5. The control system according to claim 1, wherein each of the plurality of devices are substantially identical.

6. The control system according to claim 5, wherein the controller uniquely identifies each of the plurality of devices based on the position in the sequence of electrical connections between each of the second plurality of electrical couplings with the first through the last ones of the first plurality of electrical couplings.

7. The control system according to claim 1, wherein each one of the first plurality of electrical couplings and each corresponding one of the second plurality of electrical couplings comprise at least three electrical contacts arranged in a common pattern.

8. A climate control system for a vehicle, the system comprising:
a controller directing airflow to at least one of a footwell, interior vents and a windshield defroster;
a wiring harness including a first plurality of electrical couplings connected in series with the controller, a first one of the first plurality of electrical couplings being located along the harness closest to the controller, and a last one of the first plurality of electrical couplings being located along the harness furthest from the controller; and
a plurality of devices electrically connected via the wiring harness to the controller, each of the plurality of devices being electrically connected to a respective one of the first plurality of electrical couplings via a corresponding one of a second plurality of electrical couplings;
wherein sequential electrical connection of the corresponding one of the second plurality of electrical couplings with the first through the last ones of the first plurality of electrical couplings increases a closed path of detected and identified devices, as recognized with the controller.

9. The system according to claim 8, wherein the plurality of devices comprises first, second and third actuators, the first actuator diverting at least a portion of the airflow to the footwell, the second actuator diverting at least a portion of the airflow to the interior vents, and the third actuator diverting at least a portion of the airflow to the windshield defroster, and the first, second and third actuators being substantially identical.

10. The system according to claim 8, wherein the controller selects at least one of heating, ventilating, and air conditioning.

11. A method of assembling a system including a controller, a wiring harness having at least two electrically open ports connected in series with the controller, and at least two devices, the method comprising:
identifying with the controller a first one of the devices when an electrical connection via a first one of the ports creates a closed path; and
identifying with the controller a second one of the devices when an electrical connection via a second one of the ports expands the closed path.

12. The method according to claim 11, wherein the identifying the first one of the devices consists of electrically connecting in the closed path:
the controller; and
the first one of the devices, the first one of the devices closing the first one of the ports that is located along the harness closest to the controller; and
wherein the identifying the second one of the devices consists of electrically connecting in the closed path:
the controller,
the first one of the devices closing the first one of the ports; and
the second one of the devices, the second one of the devices closing the second one of the electrical ports that is located along the harness second closest to the controller.

13. The method according to claim 11, wherein the identifying with the controller the second one of the devices follows the identifying with the controller the first one of the devices.

14. A method of assembling a system including a controller, a wiring harness having a plurality of electrically open ports connected in series with the controller, and a plurality of devices, the method comprising:
defining a closed path including only the controller and a first recognized one of the plurality of devices; and
expanding the closed path so as to include only the controller, the first recognized one of the plurality of devices, and a second recognized one of the plurality of devices.

15. The method of assembling a system according to claim 14, wherein the defining the closed path consists of electrically connecting the first recognized one of the plurality of devices across a first one of the plurality of ports, the first one of the plurality of ports being located along the harness closest to the controller; and
wherein the expanding the closed path consists of electrically connecting the second recognized one of the plurality of devices across a second one of the plurality of ports, the second one of the plurality of ports being located along the harness second closest to the controller.

16. The method according to claim 14, wherein the defining the closed path comprises the controller detecting and uniquely identifying the first recognized one of the plurality of devices.

17. The method according to claim 16, wherein the expanding the closed path comprises the controller detecting and uniquely identifying the second recognized one of the plurality of devices.

18. The method according to claim 17, wherein the plurality of devices are substantially identical.

19. The method according to claim 14, wherein feedback from the controller is used to recognize the first and second recognized ones of the plurality of devices.
